(19) United States
(12) Patent Application Publication
(10) Pub. No.: US 2015/0161667 A1
(43) Pub. Date: Jun. 11, 2015

(54) PRESENTING OFFERS TO NAVIGATIONALLY PROXIMATE USERS

(71) Applicant: INTERNATIONAL BUSINESS MACHINES CORPORATION, Armonk, NY (US)

(72) Inventors: Mark B. Stevens, Austin, TX (US); John D. Wilson, Houston, TX (US)

(73) Assignee: INTERNATIONAL BUSINESS MACHINES CORPORATION, Armonk, NY (US)

(21) Appl. No.: 14/101,823

(22) Filed: Dec. 10, 2013

(51) Int. Cl. G06Q 30/02; G06Q 30/06; G06Q 10/08

(52) U.S. Cl. CPC G06Q 30/0264; G06Q 30/0261; G06Q 30/0269; G06Q 30/0222; G06Q 10/083; G06Q 30/0635

(57) ABSTRACT

A method, system or computer usable program product for presenting offers to navigationally proximate users based on a scheduled delivery time to a first user including receiving a first user delivery address for the first user for an ordered item scheduled to be delivered at a first delivery time; utilizing a processor to determine a set of offers to a set of users who are navigationally proximate to the first user delivery address; and presenting a first offer to one of the set of navigationally proximate users based on the first user delivery address and the first delivery time, wherein the first offer is valid for a first time window calculated so that if accepted the first offer can be prepared and delivered while allowing the ordered item to be delivered within a second time window of the scheduled first delivery time.

### BACKGROUND

1. Technical Field

The present invention relates generally to presenting offers to navigationally proximate users, and in particular, to a computer implemented method for presenting offers to navigationally proximate users based on a scheduled delivery time to a another user.

2. Description of Related Art

The internet has become a worldwide shopping network for a variety of goods and services. That is, users can order a large variety of items for delivery direct to their home, office or other desirable location. These ordered items can include everything from books, jewelry, and electronics goods to quick delivery items such as pizzas, groceries, etc. The range of products and services available for order on-line is increasing every year and providing strong competition with typical brick and mortar businesses.

In addition to the wide range of products offered on-line and even by telephone, users are expecting quicker delivery of their products, often with those deliveries coming at an expected date and approximate time at any stated location. This has created the need for companies to be very flexible in their product offerings as well as delivery times and locations.

### SUMMARY

The illustrative embodiments provide a method, system, and computer usable program product for presenting offers to navigationally proximate users based on a scheduled delivery time to a first user including receiving a first user delivery address for the first user for an ordered item scheduled to be delivered at a first delivery time; utilizing a processor to determine a set of offers to a set of users who are navigationally proximate to the first user delivery address; and presenting a first offer to one of the set of navigationally proximate users based on the first user delivery address and the first delivery time, wherein the first offer is valid for a first time window calculated so that if accepted the first offer can be prepared and delivered while allowing the ordered item to be delivered within a second time window of the scheduled first delivery time.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a customer ordering processing system in which various embodiments may be implemented;

FIG. 4 is a timeline diagram of a customer obtaining an item in which various embodiments may be implemented;

FIG. 5 is a flow diagram of a customer/user placing an order in accordance with a first embodiment;

FIG. 6 is a flow diagram of a customer/user placing an order in accordance with a second embodiment; and

FIGS. 7A through 7E are block diagrams of types of database records in which various embodiments may be implemented.

### DETAILED DESCRIPTION

Processes and devices may be implemented and utilized for presenting offers to navigationally proximate users. These processes and apparatuses may be implemented and utilized as will be explained with reference to the various embodiments below.

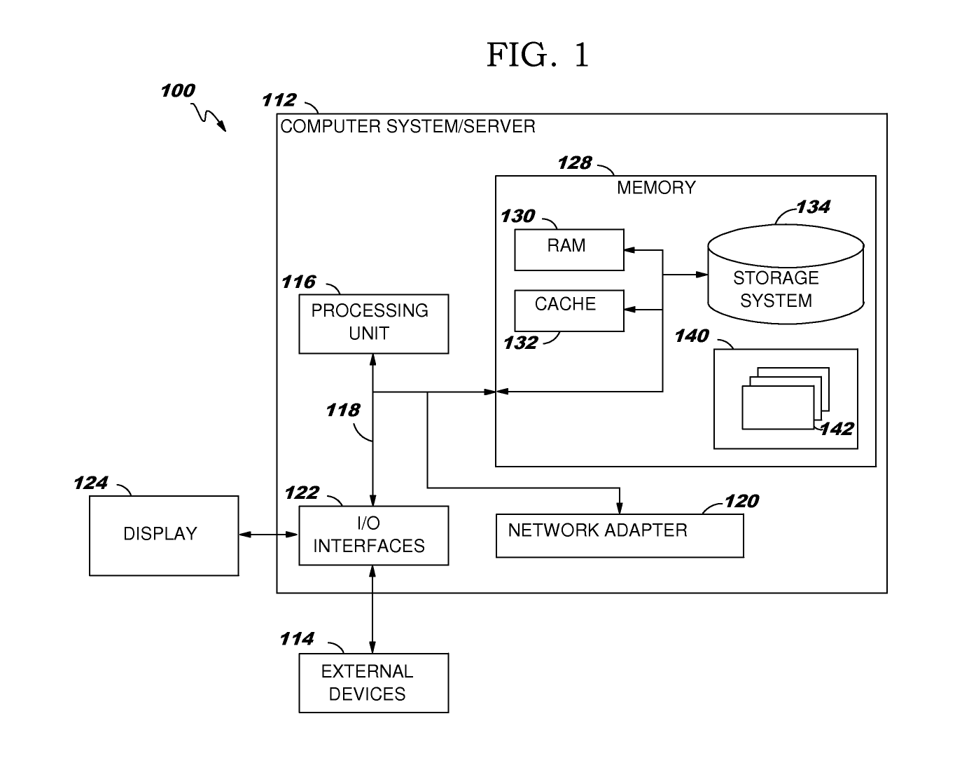

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as presenting offers to navigationally proximate users.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system readable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for presenting offers to navigationally proximate users.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

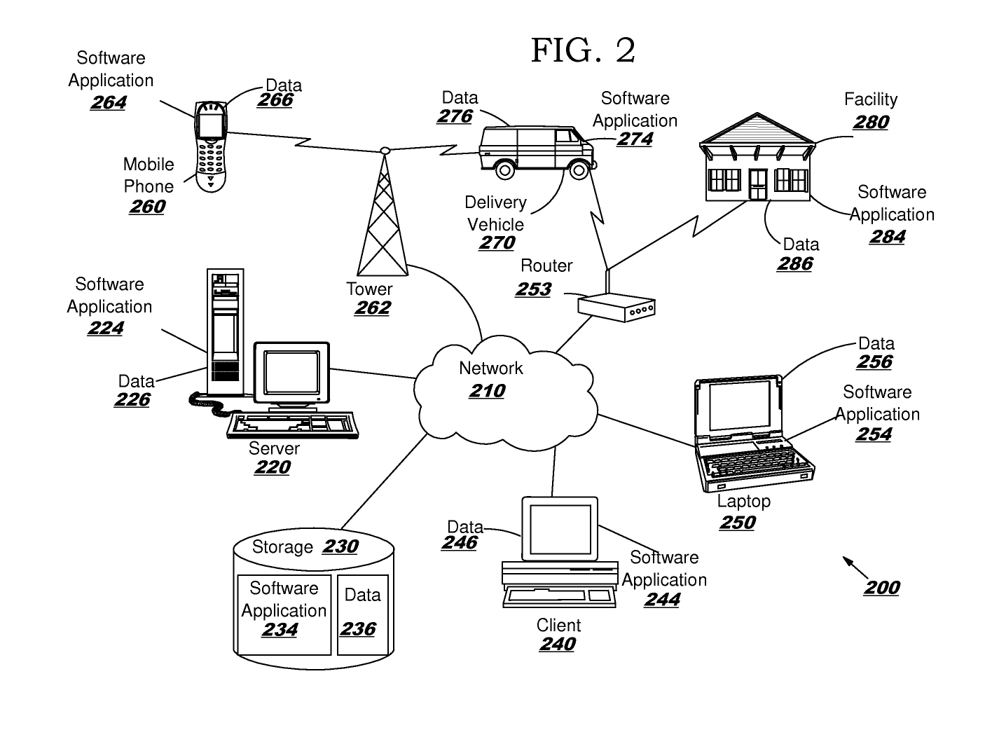

FIG. 2 is a block diagram of an illustrative network of data processing systems in which various embodiments of the present disclosure may be implemented. Data processing environment 200 is a network of data processing systems such as described above with reference to FIG. 1. Software applications such as for presenting offers to navigationally proximate users may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home, business or mail service which provides goods or services for delivery by delivery vehicle 270) are coupled to network 210 including wirelessly such as through a network router 253. A mobile phone 260 and a delivery vehicle 270 (which may be a car, van, truck or other method of conveyance including an airborne drone) may be coupled to network 210 through a mobile phone tower 262. Delivery vehicle 270 may also be coupled wirelessly through a network router when at a facility 280 or when passing by publicly open wireless networks while on the road. Data processing systems, such as server 220, client 240, laptop 250, mobile phone 260, delivery vehicle 270 and facility 280 contain data and have software applications including software tools executing thereon. Other types of data processing systems such as personal digital assistants (PDAs), smartphones, tablets and netbooks may be coupled to network 210.

Server 220 may include software application 224 and data 226 for presenting offers to navigationally proximate users or other software applications and data in accordance with embodiments described herein. Storage 230 may contain software application 234 and a content source such as data 236 for presenting offers to navigationally proximate users. Other software and content may be stored on storage 230 for sharing among various computer or other data processing devices. Client 240 may include software application 244 and data 246. Laptop 250 and mobile phone 260 may also include software applications 254 and 264 and data 256 and 266. Delivery vehicle 270 and facility 280 may include software applications 274 and 284 as well as data 276 and 286. Other types of data processing systems coupled to network 210 may also include software applications. Software applications could include a web browser, email, or other software application for presenting offers to navigationally proximate users.

Server 220, storage unit 230, client 240, laptop 250, mobile phone 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260, delivery vehicle 270 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

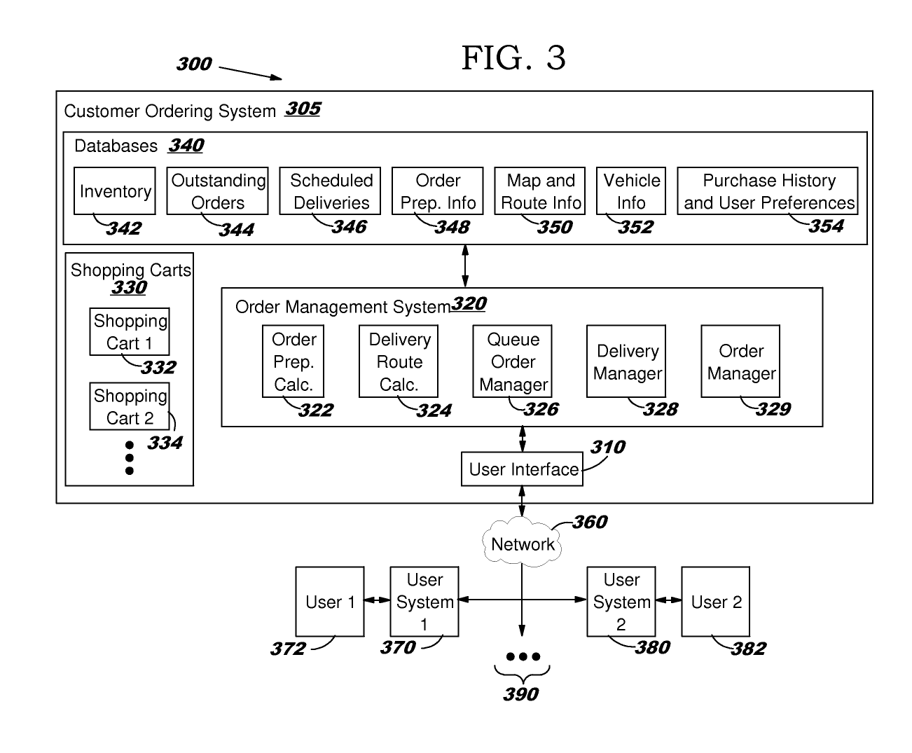

FIG. 3 is a block diagram of a customer ordering processing system 300 in which various embodiments may be implemented. A customer ordering system 305 communicates across a network 360 with user systems 370 and 380 for allowing users 372 and 382 (also referred to herein as customers) to order products. Customer ordering system 305 may be implemented on a single server, multiple servers or even in a cloud implementation. Network 360 may be the internet or other communication network. User systems 370 and 380 may be desktop computers, laptops, tablets, smart phones, or other user communication devices.

Customer ordering system 305 includes a user interface 310, an order management system 320, a set of shopping carts 330, and databases 340. User interface 310 communicates with user systems 370 and 380 across network 360. User interface 310 also communicates with order management system 320 in providing information about products to users 372 and 382. Order management system 320 maintains user shopping carts 330 including individual shopping carts 332 and 334 for each user or customer. Order management system 320 also utilizes databases 340 to offer and sell products through user interface 310, including offering discounts or other incentives for selling multiple products or services in navigationally proximate locations.

Order management system 320 includes an order preparation calculator 322, a delivery route calculator 324, a queue order manager 326, a delivery manager 328, and an order manager 329. Order preparation calculator 322 is able to determine how long it takes to prepare any given order. That can include picking a product from a warehouse, performing a set of tasks to complete a product, etc. For example, if a pizza is ordered, it would include the amount of time to prepare the pizza for baking and then baking the pizza, with some statistical period of time to handle variation. A smaller pizza may be easier to prepare and can be cooked quickly whereas a larger thick pizza with many ingredients may take more time to prepare and bake. Order management system also determines whether there are sufficient inventoried items for preparing the ordered item. If a product needs to be back ordered, the time obtaining the product available for delivery to the customer may be included in the expected time for preparing the order.

Delivery route calculator 324 calculates the time needed for delivering a product or service to a customer as well as the proximity of other potential customers. For example, a first customer may be located at a first address and a route is determined to deliver the ordered item to that customer. Other customers may be located nearby the first customer address such that discounts or other incentives for purchasing items may be offered to those other customers if they are willing to receive delivery at about the same time as the first customer. Other customers may also be located near the delivery route to the first customer such that discounts or other incentives for purchasing items may be offered to those other customers if they are willing to receive delivery at about the same time as the delivery vehicle drives nearby the other customer locations. The route to the first customer address may also be modified so that the delivery vehicle drives nearby a greater number of potential customers. The proximity may be in terms of a geographic distance from the first customer address or route to the first customer. The proximity may also be in terms of a travel time from the first customer address or route to the first customer. Other forms of proximity may also be utilized as well. Collectively, these types of proximity are referred to herein as navigationally proximate. That is, two customers are navigationally proximate if a delivery vehicle can be reasonably expected to deliver items to both customers within an expected schedule of deliveries. Deliver route calculator 324 is utilized to determine whether two or more customers are navigationally proximate and therefore capable of combining delivery of their items to a single delivery vehicle.

Order queue manager 326 manages a queue of outstanding orders for delivery. Orders to be filled are ordered in such a way so that the resulting prepared or obtained items are ready for packing into a delivery vehicle at about the same time to minimize any delays. That is, rather than a first in first out (FIFO) queue, the orders may be reordered for a variety of scheduling reasons. For example, if two items to be shipped in the same delivery vehicle take different lengths of time to prepare, then the item that takes longer to prepare may be started first, followed by the other item such that they are ready for packing and delivery at about the same time. In addition, some later ordered items may be prepared for packing and delivery first due to scheduling requirements. Order queue manager manages the queue based on these scheduling needs and requirements. Order queue manager 326 can also provide feedback regarding reordering current orders to provide parameters for making offers with incentives to certain customers or other contingency planning.

Delivery manager 328 manages the overall delivery process including the results of order preparation calculator 322, delivery route calculator 324 and queue order manager 326. For example, delivery manager 328 tracks scheduled delivery vehicle loads and can determine that a truck scheduled for making a set of deliveries at a certain time has room for additional deliveries along a preferred route. This includes inputs from the other three modules in the order management system. That is, given the queue of orders to be prepared and delivered by the truck as per order prep calculator 322 and queue order manager 326, then the delivery manager can determine that space is available for additional products on the truck on a route generated by delivery route calculator 324.

Order manager 329 works with customers through the user interface and manages shopping carts 330 to manage any ongoing user shopping sessions and offers to customer including incentives until customer orders are completed. For example, when a customer is making an order, order manager 329 can also utilize delivery manager 328 to identify delivery vehicles that are traveling within a navigationally proximate distance from that customer during the potential delivery time and then query the order preparation calculator 322 and queue order manager 326 whether the potential order could fit into one of those identified trucks (or other delivery vehicle). Once an order is completed, order manager can inform delivery manager 328 of the completed order, which can then work with the other modules to incorporate that order into the order queue and delivery schedules to be shipped on a delivery vehicle. In addition, using the route that delivery vehicle will follow and a set of potential customers that are navigationally proximate per delivery route calculator 324, order manager 329 can make special offers to that set of potential customers to try to fill the truck with additional items for delivery.

Order management system 320 utilizes databases 340 located in customer ordering system memory for assisting in the user ordering process. These databases store information utilized by order management system 320. These databases include an inventory 342, outstanding orders 344, scheduled deliveries 346, order preparation information 348, map and route information 350, delivery vehicle information 352 and purchase history and user preferences 354. Inventory 342 includes a current list of all products and services available. This is important to maintain to avoid selling items for scheduled delivery requires the availability of those items. Inventory 342 can include whether an item is available for sale or has been sold but is still in inventory awaiting selection for preparation and delivery to a customer.

Outstanding orders 344 includes a list of orders already pending preparation and/or delivery. This can include references to inventory and to scheduled routes for delivery. Outstanding orders 344 can be utilized to help identify delivery routes that can include more products as well as customers that may be contacted for additional sales or delivery time adjustments as needed. Outstanding orders 344 is also utilized to prepare a set of orders for preparation and delivery at the appropriate time.

Scheduled deliveries 346 includes a list of deliveries scheduled including references to the vehicle or type of vehicle utilized for each delivery and cross references to the outstanding orders to be delivered in each delivery. This can also include information regarding the route to be taken for deliveries for determining whether a potential customer may be navigationally proximate to an existing scheduled route.

Order preparation information 348 includes information regarding the steps necessary for preparing an order. For example, a variety of information regarding preparing a product such as pizza may be included for used in scheduling the preparation and delivery of a set of products. For example, if a dozen pizzas are to be prepared for delivery to three customers in the same delivery route, information regarding preparing different types of pizza is important in scheduling when preparation should start on each pizza. That is, thick pizzas with many ingredients may require a longer cooking time such that preparation of those types of pizzas are started before thin pizzas with fewer ingredients.

Map route information 350 includes information regarding the locale where deliveries may be scheduled. This can include a map of the locale, distances, expected travel times (which may vary by time of day), road construction, etc. The level of detail and breadth may vary significantly depending on the customer ordering system. For example, if products are sold to customers nationwide (or even internationally), then a very large database may be utilized. Third party products may be utilized including those that may be accessible across the internet.

Vehicle information 352 maintains information about each vehicle or type of vehicle utilized for deliveries. This can include cargo volume, weights limits, etc. This information is useful in identifying vehicle deliveries that could use additional products from customer navigationally proximate to fill the delivery vehicle.

Purchase history and user preferences 354 includes information about various stated user preferences such as whether the user prefers overnight delivery, credit card information, etc. It can also include preferences and other attribute information about a user such as income level, whether the user owns pets, is married, etc. that may be obtained from third parties. Purchase history with user preferences 354 also include historical information regarding prior purchases including observed trends and other analytics for use as described below.

Alternative embodiments may utilize alternative database configurations. For example, order management system 320 may include additional calculators or a single calculator for various functions. Order managements system 320 may also be combined with user interface 310. Databases 340 may be combined in alternative configurations, such as separating purchase history and user preferences 354 into two separate databases. Additional or different information may be collected and stored for use in each database.

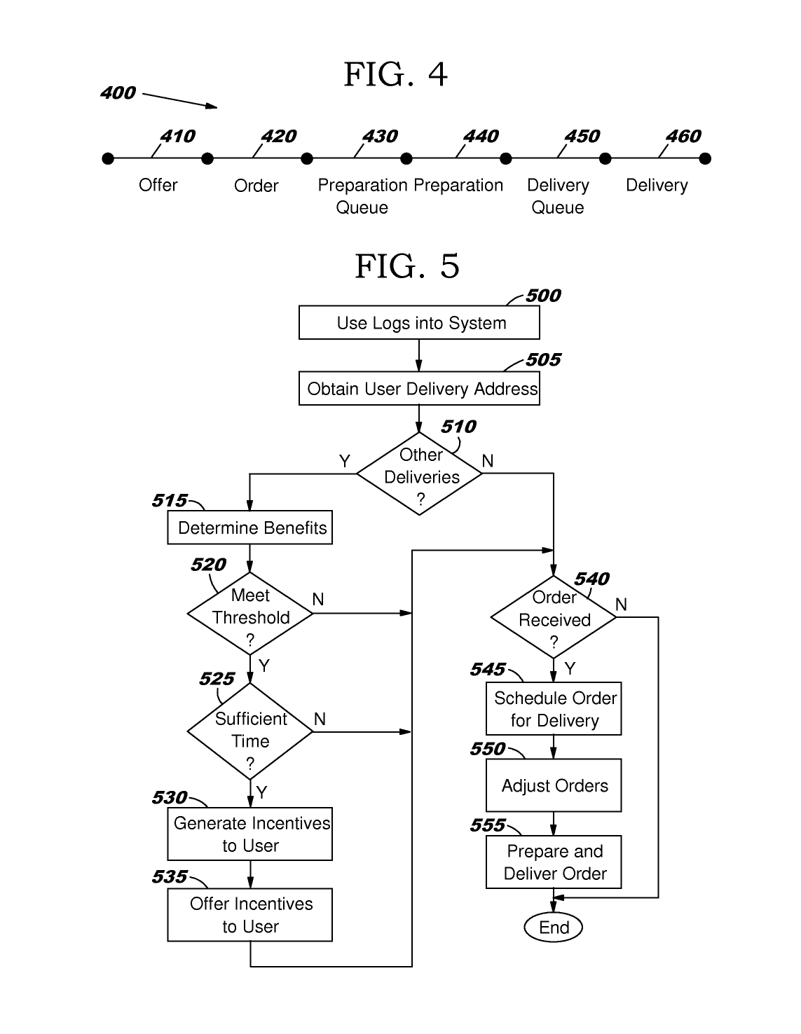

FIG. 4 is a timeline diagram 400 of a customer obtaining an item in which various embodiments may be implemented. The amount of time spent in each time period may differ significantly depending on the implementation, the type of item ordered, and other individual circumstances. A first time period referred to as offer period 410 includes the time that an offer may be made to a customer to order an item such as by email, web offering, etc. Often there may not be a pre-ordering offer, so this time period may be zero in many circumstances. A second time period for placing an order referred to as an order period 420 includes the time a customer takes making an order. This may be accomplished very quickly, such as when a customer places an order on-line or by telephone. Alternatively, it may be accomplished slowly when a customer may create a shopping cart and then logoff the system and then logon later to tend to the shopping cart.

The time between placing an order and preparing the item for delivery is a preparation queue period 430. There is no activity during this time period, although some of this period may be utilized for other periods depending on circumstances. Preparation time period 440 refers to the time needed to prepare an item for delivery. This time period can include picking an item from a warehouse and loading it onto a delivery vehicle or cooking a product and loading that with other cooked products on a delivery vehicle. This time period can also include the time needed to back order a product for future delivery. Delivery queue time period 450 includes any time where a delivery vehicle has been loaded for delivery, but the delivery does not start yet. This can include the delivery vehicle being packed in the evening but deliveries not starting until the next morning. It can also include delaying the delivery vehicle to complete and pack a last minute order. The final time period is delivery period 460 which is the time necessary to deliver a given item once the delivery vehicle starts the delivery process. This time period can vary for each item packed in the delivery vehicle. For example, the last item delivered may have a longer time period for delivery than any other item.

Each item ordered may have a different timeline and different sets of time periods depending on circumstances. For example, one product may have been ordered first and take longer to prepare, so it may have a longer timeline that other items, even those delivered on the same vehicle. The common element between items delivered together is their navigational proximity. Each time period may include a buffer or other statistical measure for handling contingencies. For example, a delivery time period may be expressed as a confidence interval based on prior experience. In addition, each point on FIG. 4 can be expressed as a time window allowing for variation while meeting the timing requirements of each item to be delivered.

FIG. 5 is a flow diagram of a customer/user placing an order in accordance with a first embodiment. In this embodiment, there may be a large number of existing deliveries scheduled which a new order may be combined with. In addition, there may be multiple concurrent users in the process of making an order to which this process could apply, although the below is described with reference to a single user.

In a first step 500, the user logs onto a website or other system for placing an order. In a second step 505, the system obtains the delivery address of the user. The delivery address is important for identifying deliveries that may occur that are navigationally proximate to the user. The delivery address may be obtained directly from the user or may be obtained from user preferences or prior user history stored in memory. Subsequently in step 510, the delivery manager and delivery calculator use the scheduled delivery database and the map and route information database to check upcoming scheduled deliveries (within a scheduled time window) that are not full to see if any route is navigationally proximate to the user's delivery address. If no in step 510, then no incentives are offered to the user and processing continues to step 540 below. If yes in step 510, then in step 515 a determination is made for each identified delivery the benefit for adding another item to each of those deliveries at the user's delivery address.

Then in step 520, the benefits are compared and a determination is made whether a threshold was met to support providing an incentive to the user. If no in step 520, then no incentives are offered to the user and processing continues to step 540 below. If yes in step 520, then in step 525 it is determined whether there is sufficient time for the user to make an order (an offer time window) and any items ordered to be delivered to the user in the identified beneficial deliveries (a delivery time window). This includes determining whether the preparation start time of other items in the delivery can be sped up or delayed to allow a larger offer time window to the user. If no in step 525, then no incentives are offered to the user and processing continues to step 540 below, otherwise processing continues to step 530.

In step 530 incentives are generated for offer to the user within an offer time window for making an order meeting certain constraints. An incentive is generated to encourage the user to make an order. An incentive may be a monetary discount, points, a discount on a future order, lower delivery charge, etc. These incentives may be scaled by the order manager based on the expected benefit. Constraints on the incentives may also be provided given the constraints on what may be ordered and make the delivery deadlines. For example, if pizzas are being ordered, then a new order of 60 pizzas may not be prepared in time for delivery due to the large number and the limited capabilities, so quantity limitations may apply. In addition, based on the items or quantities ordered, the time window for accepting the offered incentives may be adjusted to take into account the preparation time for the items or quantities ordered by the user. For another example, certain classes of items may take a long time to prepare (including picking from a remote warehouse) and may also be excluded from the incentives. Alternatively, the incentives may be offered only for selected products or services that meet the constraints and are likely to be taken by the user based on prior user history. Inventory may also be checked to determine whether the offered products are available for delivery. Another constraint included is a delivery time window. Given the delivery time(s) of other items being delivered in the same delivery vehicle and route, a delivery time window is proposed to the user as another constraint.

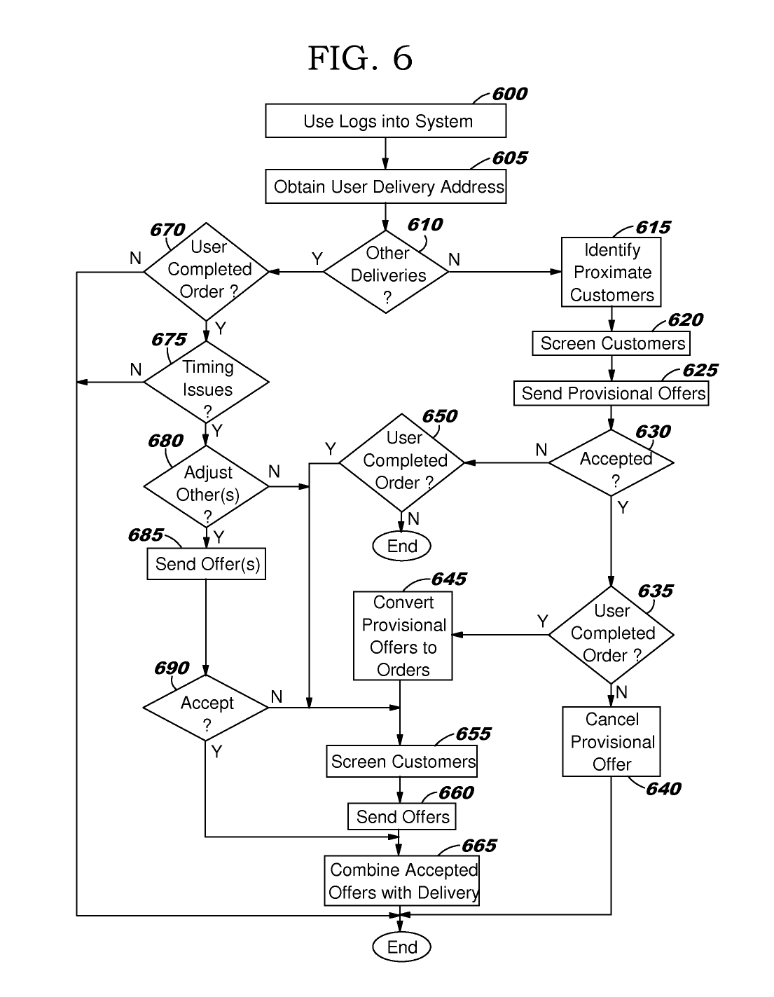

Then in step 535, an incentive offer is presented to the user with the above constraints including a time window for accepting the incentive offer and a time window the product will be delivered. If the time window for the offer is short (e.g., one hour or less), then a countdown timer may also be provided to remind the user of the timing constraints. If there is a high likelihood of user acceptance of the incentive and one or more items ordered as a result, the preparation of other products for the same delivery may be delayed somewhat if that delay would not significantly affect the final delivery time for those products (i.e. within a delivery window for those products). Incentives may also be offered to the other customers to delay their orders as described below with reference to FIG. 6.

In step 540, it is determined whether the user has made an order. If not, then processing ceases, otherwise in step 545 the order is scheduled for delivery. This can include checking inventory for availability of the item(s) ordered, determining the time needed to prepare the item(s) ordered, checking existing deliveries for navigational proximity to the user (which may have already been determined above), check delivery vehicle availability to carry the ordered item(s) with any existing delivery (e.g. determine that there is sufficient room on the delivery vehicle), etc. Once scheduled, then in step 550 the queue order manager in conjunction with the order preparation calculator may adjust the order of item preparation of multiple orders and deliveries to make the scheduled delivery. Finally, in step 555, the scheduled delivery is prepared, loaded for delivery and delivered at the scheduled time.

FIG. 6 is a flow diagram of a customer/user placing an order in accordance with a second embodiment. In this embodiment, while a user is making an order, the system initiates offers or provisional offers to other users. These offers or provisional offers can include modifying a prior order by the other users or initiating a new offer with the other users. This embodiment may be performed during or after the first embodiment described above.

In a first step 600, a first user logs onto a website or other system for placing an order. In a second step 605, the system obtains the delivery address of the first user. The delivery address is important for identifying deliveries that may occur that are navigationally proximate to the user. The delivery address may be obtained directly from the first user or may be obtained from user preferences or prior user history stored in memory. Subsequently in step 610, the delivery manager and delivery calculator use the scheduled delivery database and the map and route information database to check upcoming scheduled deliveries (within a scheduled time window) that are not full to see if any route is navigationally proximate to the first user's delivery address. If yes in step 610, then processing continues to step 670 below. If no in step 610, a new delivery may be needed for the first user's order, so processing continues to step 615 to try to generate other orders to join the first user's order and delivery. In step 615 a set of customers are identified from any other users within the user preferences database which may be navigationally proximate to the first user's delivery address. Then in step 620, that set of potential customers is screened for possible sales opportunities. This can include user preferences and prior historical information (e.g., a potential customer orders two large pizzas every Thursday evening).

While the first user is in the process of making his or her order, provisional offers with incentives may then be sent in step 625 to certain potential customers in anticipation of a completed first user order. These provisional offers may be sent by text, email, or other quick means of communication. These provisional offers are provisional in that they depend on the first user completing his or her order. There may be other constraints such as timing and delivery time constraints. That is, the provisional offers may be for a specific time window which may meet any timing constraints from the first user. In step 630, it is determined whether any of the provisional offers have been accepted. If not, then processing continues to step 650, otherwise in step 635 it is determined whether the first user completed his or her order. If not in step 635, then in step 640 the provisional offer is declined and the customer which had accepted that provisional offer is notified. That customer may still be given certain awards based on that customer's participation in this process. Processing then ceases. If the first user completed the order as expected in step 635, then in step 645 the accepted provisional offers are converted into orders for delivery with the first customer's order. Processing then continues to step 655.

In step 650, no provisional offers have been accepted and the first user has not completed his or her order. If it is determined in step 650 that the first user did not complete the order, then processing ceases. Otherwise, if the first user did complete an order, then processing continues to step 655. Then in step 655, the set of potential customers (which includes existing customers) identified in step 615 above are again screened to determine whether there may be some new sales or upsells which can also fit within the delivery of the first user's order. In step 660, new non-provisional offers are sent to the screened customers to try to add additional items to the delivery scheduled for the first user's order. These offers will include timing windows so that any accepted offers can be delivered with the first user's order. In step 665, any such accepted offers are then accepted and combined with the first user's order and processing ceases.

In step 670, there are other deliveries that are navigationally proximate to the first user's delivery address. It is determined in step 670 whether the first user has completed his or her order. If not, then no further processing is needed and processing ceases, otherwise processing continues to step 675. In step 675, it is determined whether there are timing issues with the first user's order. That is, the first user's order may be completed too late or scheduled too late to make the scheduled delivery (i.e., not within the scheduled delivery time window). This can include determining the state of preparation of orders of the scheduled deliveries if such preparation has already begun. If not in step 675, then no adjustments are needed, the first user's order can be combined with the delivery and processing ceases. If yes in step 675, then in step 680 it is determined whether some other orders of the delivery may be delayed or otherwise adjusted to allow the first user's order may be shipped with the rest of the delivery (i.e., to modify or otherwise adjust the scheduled delivery time window). This can include a threshold test based on the benefit of delaying the other orders. If not, then a new delivery will be needed to deliver the first user's order and processing continues to step 655. Otherwise, in step 685 incentives are sent to certain other customers of the scheduled delivery to delay or otherwise adjust their scheduled delivery times. That is, those customers with other order deliveries in conflict with the first user's order delivery are provided incentives to adjust their delivery time to combine the orders into a single delivery. In step 690 it is determined whether these other incentive offer(s) have been accepted. If not, then the order cannot be combined into a single order and processing continues to step 655, otherwise the orders may be combined into a single delivery and processing continues to step 665.

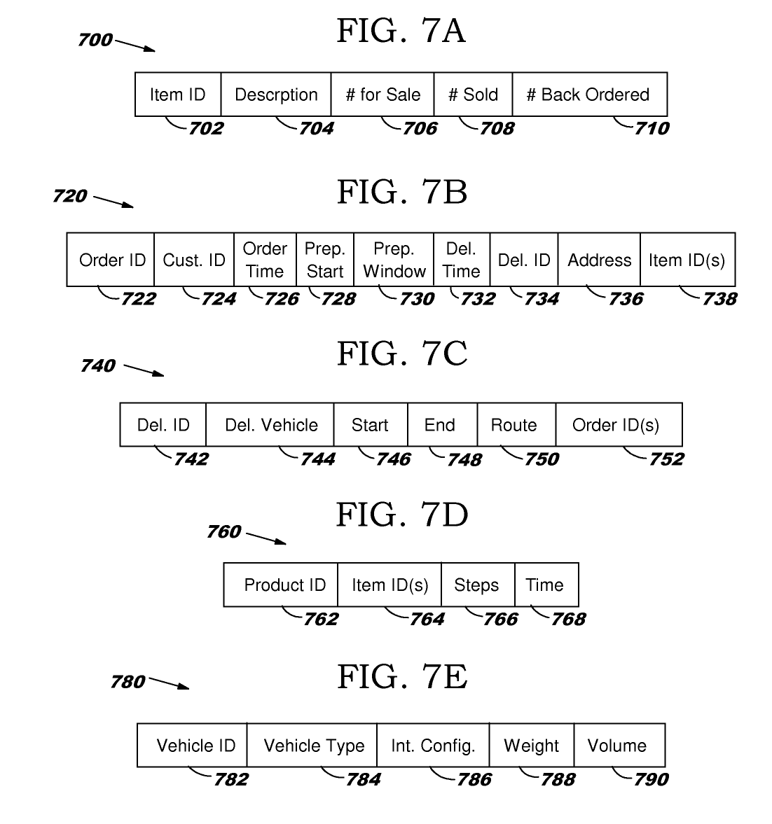

FIGS. 7A through 7E are block diagrams of types of database records in which various embodiments may be implemented. A record is a set of information within a domain or database that establishes a relationship between a set of data or data elements. A record may be a separate entry into a database, a set of links between data, or other logical relationship between a set of data. FIG. 7A is a block diagram of a record 700 stored in an inventory database. FIG. 7B is a block diagram of a record 720 stored in an outstanding orders database which is utilized to track outstanding orders not yet delivered. FIG. 7C is a block diagram of a record 740 stored in a scheduled deliveries database which can be cross referenced with the outstanding orders database. FIG. 7D is a block diagram of a record 760 stored in an order preparation database for use in providing process steps and time required to prepare certain ordered items for delivery. FIG. 7E is a block diagram of a record 780 stored in a vehicle information database for use in providing information about the fleet of delivery vehicles and their capabilities. The records described below are examples and alternative embodiments may utilize other structures and types of data utilized for implementation. General usage map and route information databases as well as purchase history and user preferences databases and are well known and can include third party products.

FIG. 7A is a block diagram of a record 700 stored in an inventory database. There can be a single record for each item or class of items, although alternative embodiments may differ. For example, multiple items may be assembled into a single product so that there may be multiple records for an assembled item ordered. Each record includes an item identifier 702, an item description 704, a quantity of items available for immediate sale 706, a quantity of items sold but not delivered yet 708 and a quantity of items backordered 710. Additional information such as statistical information including average sales per time period, seasonal variations in sales, and minimum quantities before ordering more items may also be stored in this database.

FIG. 7B is a block diagram of a record 720 stored in an outstanding orders database which is utilized to track outstanding orders not yet delivered. There may be a single record for each order, although multiple orders by the same customer may be combined. Also, if an order is split into multiple deliveries due to ordered item availability, one record may be created for each delivery. Each record includes an order identifier 722 for tracking the order, a customer identifier 724 for tracking the customer for the order, an order time and date 726 when the order was made, a preparation start time 728, a preparation time window 730, a delivery date 732 when the ordered items are to be delivered, a delivery identifier 734 for cross referencing with the scheduled delivery of record 740 below, a delivery address 736, and a list of item identifiers 738 which identify the items ordered and to be delivered to the customer. As described below, if multiple items are assembled into a single product, then product identifiers, such as in record 760 below, may be stored instead. Additional information may be stored including any incentives utilized to generate the order.

FIG. 7C is a block diagram of a record 740 stored in a scheduled deliveries database which can be cross referenced with the outstanding orders database. There can be a single record for each delivery scheduled. Each record includes a delivery identifier 742, a delivery vehicle or type of delivery vehicle 744, a scheduled start time and date for the delivery 746, a scheduled end time and date for the delivery 748, a delivery route 750, and a list of order identifiers 752 which identifies each order to be delivered. Additional information such as delivery driver, items carried, etc. may also be stored in this record.

FIG. 7D is a block diagram of a record 760 stored in an order preparation database for use in providing process steps and time required to prepare certain ordered items for delivery. There may be a record for each product or type of product available to order. For example, if multiple items may be assembled or otherwise prepared into a single product to be ordered, then there may be a record for each assembled product available for order. Each record includes a product identifier 762, a set of item identifier(s) 764 including all items used to prepare the product for delivery, a set of steps 766 for assembling or otherwise preparing the ordered product, and time required 768 to perform the preparation steps. This information can be utilized for identifying items utilized to prepare a product for checking with inventory, how long it takes to prepare the product for scheduling purposes, etc.

FIG. 7E is a block diagram of a record 780 stored in a vehicle information database for use in providing information about the fleet of delivery vehicles and their capabilities. There can be one record for each vehicle. Alternatively, there may be one record for each vehicle type with a quantity of each type of vehicle. Each record contains a delivery vehicle identifier 782, a delivery vehicle type 784. A vehicle internal configuration (e.g., number of shelves) 786, a vehicle wright load limit 788 and a vehicle load volume 790. This information can be utilized to determine whether the delivery vehicle can store additional items for delivery. Additional information may also be stored in each record such as vehicle performance characteristics (e.g., fuel mileage) or wireless communications capabilities.

The invention can take the form of an entirely software embodiment, or an embodiment containing both hardware and software elements. In a preferred embodiment, the embodiments are implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for presenting offers to navigationally proximate users. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of presenting offers to navigationally proximate users based on a scheduled delivery time to a first user comprising:
receiving a first user delivery address for the first user for an ordered item scheduled to be delivered at a first delivery time;
utilizing a processor to determine a set of offers to a set of users who are navigationally proximate to the first user delivery address; and
presenting a first offer to one of the set of navigationally proximate users based on the first user delivery address and the first delivery time, wherein the first offer is valid for a first time window calculated so that if accepted the first offer can be prepared and delivered while allowing the ordered item to be delivered within a second time window of the scheduled first delivery time.

2. The method of claim 1 wherein a second offer is sent to the first user which includes an adjusted delivery time for a discounted price to optimize a delivery vehicle route based on other user orders from ones of the set of navigationally proximate users.

3. The method of claim 1 further comprising:
detecting that the first offer is accepted; and
adjusting preparation of the ordered item and the first delivery schedule time to accommodate the accepted first offer.

4. The method of claim 1 further comprising presenting subsequent offers valid for a second time window after the first offer acceptance.

5. The method of claim 1 wherein the first time window is calculated based on a state of preparation of the ordered item.

6. The method of claim 1 wherein the first time window is dynamically adjusted based on acceptance of the first offer.

7. The method of claim 1 wherein presenting a first offer to one of the set of navigationally proximate users is contingent on a benefit of an acceptance of the first offer meets a threshold benefit.

8. The method of claim 7 further comprising detecting that the first offer is accepted; adjusting preparation of the ordered item and the first delivery schedule time to accommodate the accepted first offer; and presenting subsequent offers valid for a second time window after the first offer acceptance; wherein a second offer is sent to the first user which includes an adjusted delivery time for a discounted price to optimize a delivery vehicle route based on other user orders from ones of the set of navigationally proximate users; wherein the first time window is calculated based on a state of preparation of the ordered item; and wherein the first time window is dynamically adjusted based on acceptance of the first offer.

9. A computer usable program product comprising a non-transitory computer usable storage medium including computer usable code for use in presenting offers to navigationally proximate users based on a scheduled delivery time to a first user, the computer usable program product comprising code for performing the steps of:
receiving a first user delivery address for the first user for an ordered item scheduled to be delivered at a first delivery time;
utilizing a processor to determine a set of offers to a set of users who are navigationally proximate to the first user delivery address; and
presenting a first offer to one of the set of navigationally proximate users based on the first user delivery address and the first delivery time, wherein the first offer is valid for a first time window calculated so that if accepted the first offer can be prepared and delivered while allowing the ordered item to be delivered within a second time window of the scheduled first delivery time.

10. The computer usable program product of claim 9 wherein a second offer is sent to the first user which includes an adjusted delivery time for a discounted price to optimize a delivery vehicle route based on other user orders from ones of the set of navigationally proximate users.

11. The computer usable program product of claim 9 further comprising code for performing the steps of:
detecting that the first offer is accepted; and
adjusting preparation of the ordered item and the first delivery schedule time to accommodate the accepted first offer.

12. The computer usable program product of claim 9 further comprising code for performing the step of presenting subsequent offers valid for a second time window after the first offer acceptance.

13. The computer usable program product of claim 9 wherein the first time window is calculated based on a state of preparation of the ordered item.

14. The computer usable program product of claim 9 wherein the first time window is dynamically adjusted based on acceptance of the first offer.

15. A data processing system for presenting offers to navigationally proximate users based on a scheduled delivery time to a first user, the data processing system comprising:
a processor; and
a memory storing program instructions which when executed by the processor execute the steps of:
receiving a first user delivery address for the first user for an ordered item scheduled to be delivered at a first delivery time;
utilizing the processor to determine a set of offers to a set of users who are navigationally proximate to the first user delivery address; and
presenting a first offer to one of the set of navigationally proximate users based on the first user delivery address and the first delivery time, wherein the first offer is valid for a first time window calculated so that if accepted the first offer can be prepared and delivered while allowing the ordered item to be delivered within a second time window of the scheduled first delivery time.

16. The data processing system of claim 15 wherein a second offer is sent to the first user which includes an adjusted delivery time for a discounted price to optimize a delivery vehicle route based on other user orders from ones of the set of navigationally proximate users.

17. The data processing system of claim 15 further comprising:
detecting that the first offer is accepted; and
adjusting preparation of the ordered item and the first delivery schedule time to accommodate the accepted first offer.

18. The data processing system of claim 15 further comprising presenting subsequent offers valid for a second time window after the first offer acceptance.

19. The data processing system of claim 15 wherein the first time window is calculated based on a state of preparation of the ordered item.

20. The data processing system of claim 15 wherein the first time window is dynamically adjusted based on acceptance of the first offer.
